(19) United States
(12) Patent Application Publication
(10) Pub. No.: US 2006/0209095 A1
(43) Pub. Date: Sep. 21, 2006

(54) Over-driving apparatus and method thereof

(76) Inventor: Ying-Hao Hsu, Tainan (TW)

Correspondence Address: TROP PRUNER & HU, PC, 1616 S. VOSS ROAD, SUITE 750, HOUSTON, TX, 77057-2631, US

(21) Appl. No.: 11/365,227

(22) Filed: Mar. 1, 2006

(30) Foreign Application Priority Data
Mar. 2, 2005 (TW) 94106353

(51) Int. Cl. G09G 5/10

(52) U.S. Cl. 345/690

(57) ABSTRACT

An over-driving apparatus, for use with a display device, receives a plurality of pixel gray values of a pixel in a plurality of frames. The apparatus includes a storage unit for storing the pixel gray values, and an over-driving generation unit, coupled to the storage unit, for outputting an over-driving gray value for the pixel in a particular frame according to the pixel gray values of the pixel in at least three of the plurality of frames, the at least three frames including the particular frame.

### CROSS-REFERENCE TO RELATED APPLICATION

This claims priority under 35 U.S.C. § 119 of Taiwan application Serial No. 94106353, filed Mar. 2, 2005, the subject matter of which is incorporated herein by reference.

### TECHNICAL FIELD

The invention relates in general to an over-driving apparatus and method thereof.

### BACKGROUND

FIG. 1A illustrates two graphs that show, respectively, example pixel gray values and brightness over time in a conventional liquid crystal display (LCD). As shown in FIG. 1A, when the pixel gray value (corresponding to the input pixel signal applied to a pixel) changes from g0 to g1 at time t0, the corresponding pixel brightness changes from Y0 to Y1. However, due to the slow response time of a typical LCD, the transition of the brightness of Y0 to Y1 does not occur in one frame period (t1−t0) even though the pixel gray scale value transition occurred at the beginning of the frame period (time t0).

Conventionally, to address the slow response time of the LCD, an over-driving technique is used to reduce the response time in switching pixel brightness from one brightness to another brightness. For example, as shown in FIG. 1B, to shorten the response time in switching pixel brightness, the pixel gray value (applied to the pixel) is over-driven to a pixel gray scale value that is higher than the target gray scale value g1. The gray scale value is driven from g0 to g1′ (g1′>g1), so that the pixel brightness can reach the value Y1 from Y0 in one frame period (t1−t0). The gray value g1′ is referred to as an “over-driving gray value.” The technique of driving the gray scale value to a value higher than the target gray scale value in the depicted example for accelerating liquid crystal rotation to reach the desired pixel brightness is referred to as an “over-driving” technique.

FIG. 2A is a block diagram of an over-driving mechanism 200 with a conventional LCD panel 240 having an I×J resolution. The over-driving mechanism 200 includes a control unit 210, frame memory 220, and an over-driving lookup unit 230. The control unit 210 is for receiving a pixel gray value of each pixel in each frame. The gray value of the (i, j)-th pixel (in the i-th row and the j-th column) in a subsequent to-be-displayed frame (the (M+1)-th frame) is denoted by G(M+1, i, j), where 1≦i≦I, and 1≦j≦J. The M-th frame is the currently displayed frame, while the (M+1)th frame is the subsequent frame to be displayed (after the current frame). The gray value of the (i, j)-th pixel for the M-th frame is denoted by G(M, i, j). The frame memory 220 is for storing all the pixel gray values of the M-th frame. The over-driving lookup unit 230 outputs an over-driving gray value God(M+1, i, j) to the LCD panel 240 according to the pixel gray value G(M+1, I, j) of the (I, j)-th pixel in the (M+1)-th frame and the pixel gray value G(M, i, j) of the (I, j)-th pixel in the M-th frame, based on checking an over-driving lookup table 232.

As shown in FIG. 2B, the conventional over-driving lookup table 232 is a 2-D (two-dimensional) lookup table. The X axis denotes gray values G(M) of the M-th frame while the Y axis denotes gray values G(M+1) of the (M+1)-th frame. If a gray value is represented by an 8-bit value, for example, each of the gray values G(M) and G(M+1) has 256 possible values, 0-255. By checking the lookup table 232, the over-driving gray value God(M+1) of a particular pixel in the (M+1)-th frame can be obtained according to the gray value G(M+1) of the pixel in the (M+1)-th frame and the gray value G(M) of the pixel in the M-th frame.

The above-mentioned over-driving lookup table 232 is a static over-driving lookup table because only the gray values G(M+1) of the (M+1)-th frame and the gray values G(M) of the M-th frame are considered in obtaining the respective over-driving gray scale values God(M+1). The static over-driving lookup table 232 assumes that the gray value has stayed constant over the previous two frames, the (M−1)-th and the M-th frames, before the subsequent frame M+1. In other words, it is assumed that the gray value G(M−1) of a pixel in the (M−1)-th frame is equal to the gray value G(M) of the pixel in the M-th frame. However, in fact, the gray value G(M−1) of a pixel in the (M−1)-th frame may be different from the gray value G(M) of the pixel in the M-th frame. This may be the case where the displayed image is not a static or monotonous image but an image of a motion picture. If G(M−1) is not equal to G(M), then the God(M+1) value obtained from the static over-driving lookup table 232 may not produce the desired behavior.

As shown in the example FIG. 3A, if the gray value before the time t0 is not a constant value g0, but a value g3 before falling to the value g0, when the over-driving gray value is chosen to be g1′, the pixel brightness does not reach the expected value Y1 from Y0 in one frame period (t1−t0), but overshoots to a higher value Y2 first before falling back to the desired value Y1 gradually.

### BRIEF DESCRIPTION OF THE DRAWINGS

FIG. 1A illustrates graphs of pixel gray values and brightness over time in a conventional liquid crystal display (LCD).

FIG. 1B illustrates graphs of pixel gray values and brightness over time when a conventional over-driving technique is used.

FIG. 2A is a block diagram of an over-driving mechanism in the conventional LCD.

FIG. 2B is a schematic diagram of a conventional over-driving lookup table.

FIG. 3A illustrates graphs of pixel gray values and brightness over time when a conventional over-driving technique is used.

FIG. 3B illustrates graphs of pixel gray values and brightness over time when an over-driving technique according to an embodiment is used.

FIG. 4A is a block diagram of an over-driving mechanism according to an embodiment of the invention.

FIG. 4B is a block diagram of an over-driving mechanism that is a variation of the FIG. 4A embodiment.

FIG. 4C is a block diagram of an over-driving mechanism that is another variation of the FIG. 4A embodiment.

FIG. 4D is a schematic diagram showing that the difference of the pixel gray values of the last two frames is divided into five gray value ranges.

FIG. 4E illustrates an example three-dimensional over-driving lookup table used in the over-driving mechanism of FIG. 4C.

FIG. 4F is a block diagram of an over-driving mechanism according to another embodiment.

FIG. 5 is a flow chart of the over-driving method according to an embodiment of the invention.

FIG. 5A is the first detailed flow chart of the over-driving method of FIG. 5.

FIG. 5B is the second detailed flow chart of the over-driving method of FIG. 5.

FIG. 5C is the third detailed flow chart of the over-driving method of FIG. 5.

FIG. 5D is the fourth detailed flow chart of the over-driving method of FIG. 5.

FIG. 6A is a block diagram of an over-driving mechanism according to yet another embodiment of the invention.

FIG. 6B is a schematic diagram of a three-dimensional over-driving lookup table used in the over-driving mechanism of FIG. 6A.

FIG. 6C is another block diagram of an over-driving mechanism that is a variation of the FIG. 6A embodiment.

FIG. 6D is a flow chart of the over-driving method according to another embodiment of the invention.

FIG. 6E is a flow chart of the over-driving method according to another embodiment of the invention.

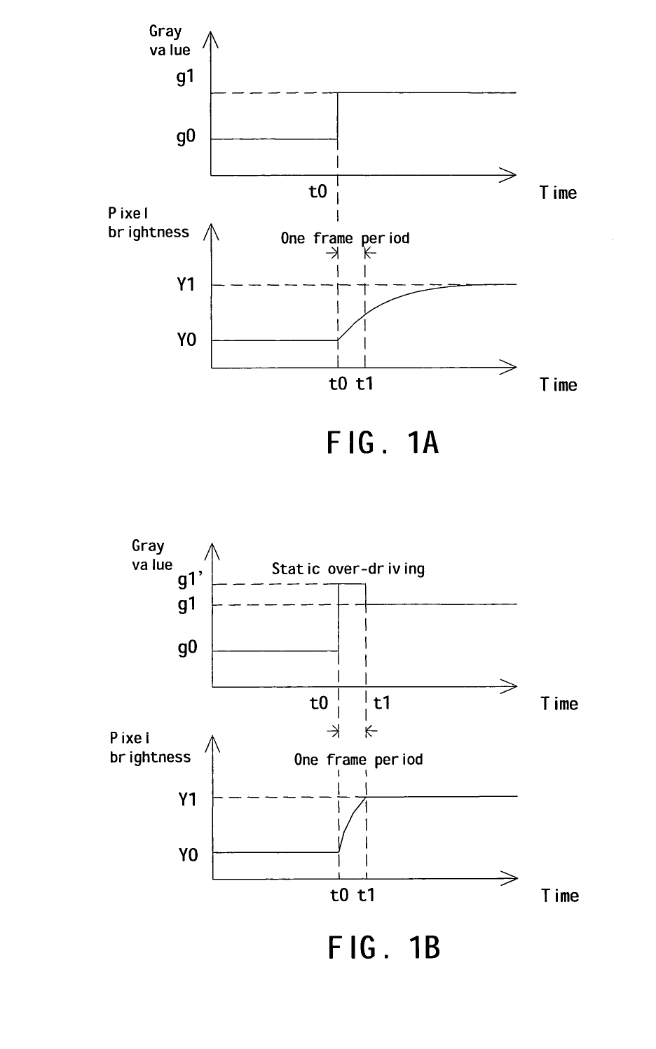

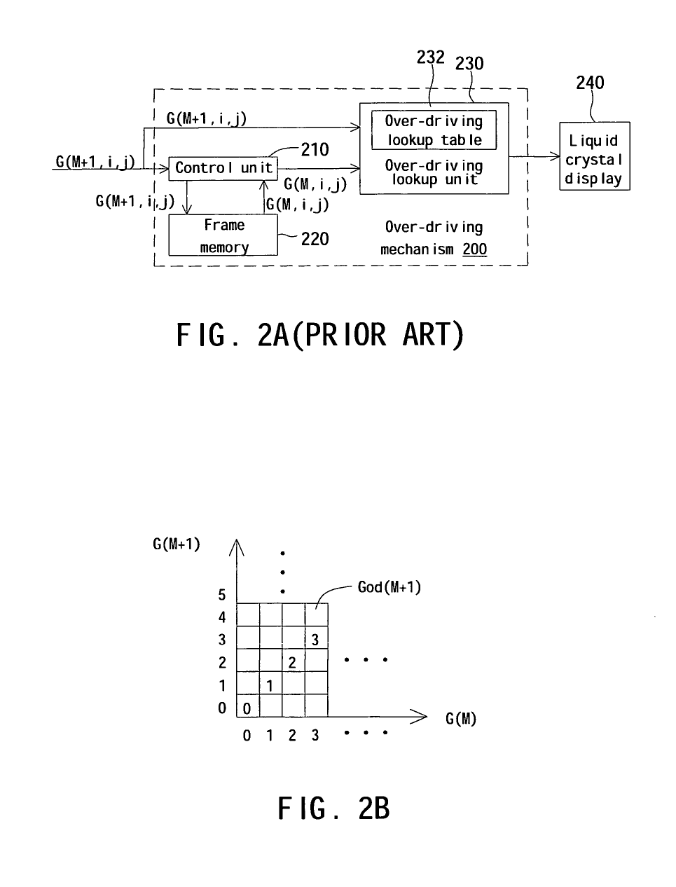

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

In accordance with some embodiments, an over-driving mechanism is provided that has an over-driving generation unit to generate over-driving gray values for driving pixels of a display device, such as a liquid crystal display (LCD) panel. An “over-driving gray value” refers to a gray value that is different from a target gray value for a pixel, which over-driving gray value is provided to ensure that switching of the brightness of the pixel to a target brightness is achieved within a single frame period. If the pixel gray value of a pixel in a subsequent frame to be displayed is greater than the pixel gray value of the pixel in a current frame, then the over-driving gray value is greater than the pixel gray value (the target gray value) of the pixel in the subsequent frame. However, if the pixel gray value of a pixel in a subsequent frame to be displayed is less than the pixel gray value of the pixel in a current frame, then the over-driving gray value is less than the target gray value of the pixel in the subsequent frame.

The over-driving gray value for a given pixel is obtained from gray values for the given pixel in at least three frames: (M+1)-th frame (subsequent frame to be displayed); M-th frame (the frame one frame period before the (M+1)-th frame); and (M−1)-th frame (the frame one frame period before the M-th frame), or two frame periods before the (M+1)-th frame). The obtained over-driving gray value is the target gray value for driving the given pixel in the (M+1)-th frame. The (M+1)-th frame, also referred to as the subsequent frame to be displayed, is the frame for which a display device is generating pixel signals to develop an image to be displayed.

The over-driving gray value obtained for the (M+1)-th frame is converted into a pixel signal that is driven over a data line of a display panel to the given pixel. By obtaining the over-driving gray value according to gray values in the at least three frames (rather than from just two frames as conventionally performed), the selected over-driving gray value can factor in any changes in gray values for the given pixel in the frames immediately preceding the subsequent frame to be displayed. As a result, the selected over-driving gray value does not assume that gray values in a preceding plurality of (e.g., two) frames were constant, an assumption that may not be applicable in continually changing displayed images such as with images of a motion picture.

A “frame” represents a complete image from a series of images. A “frame period” contains an active period and a blanking period, where the active period is the time period to drive all pixels of the display panel, and the blanking period is used to match the period for blanking performed in traditional CRT (cathode ray tube) monitors (and which are used in LCD panels for legacy purposes).

Described below are various embodiments of over-driving mechanisms for obtaining over-driving gray values for pixels of an LCD panel. Although described in the context of LCD panels, note that embodiments of the invention are applicable to other types of display devices. “Obtaining” an over-driving gray value refers to retrieving the over-driving gray value from a storage location (such as a lookup table) or computing the over-driving gray value.

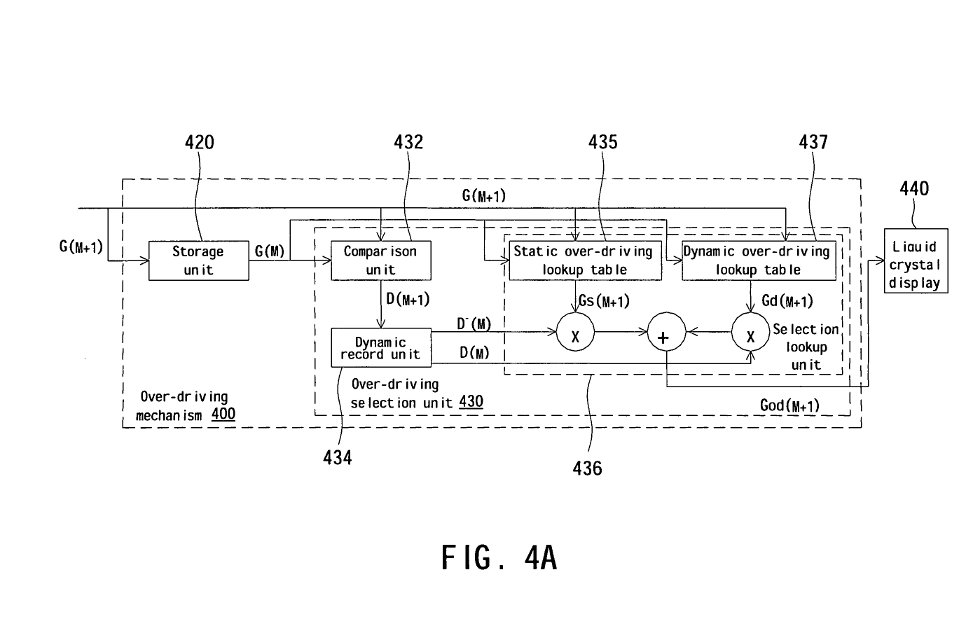

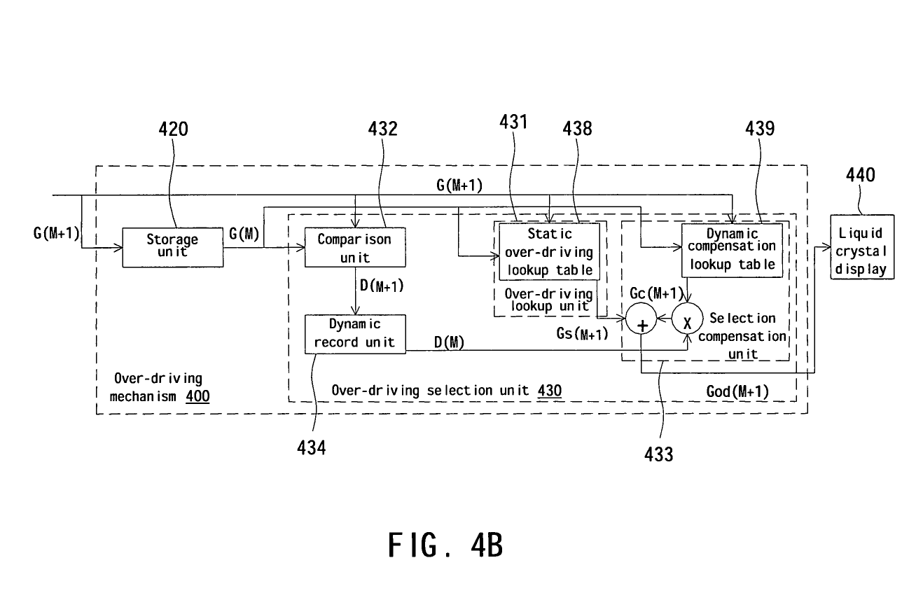

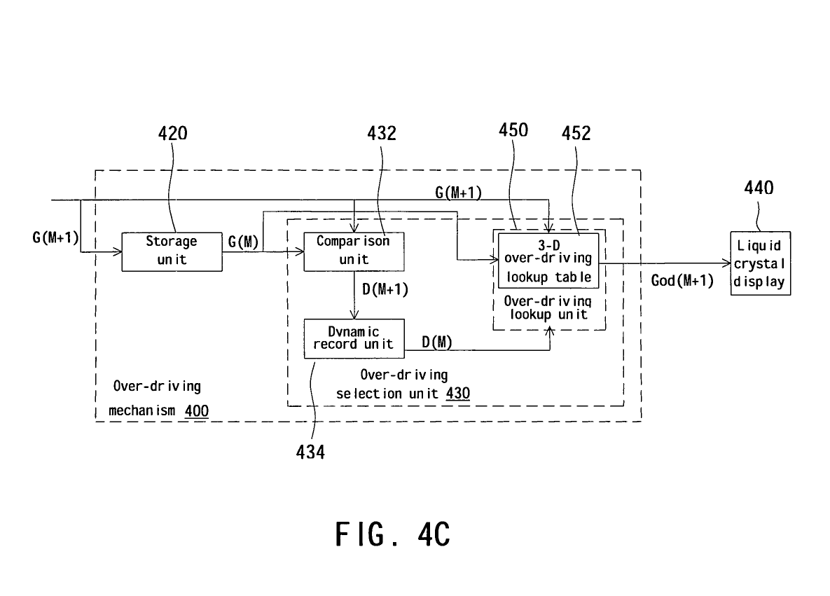

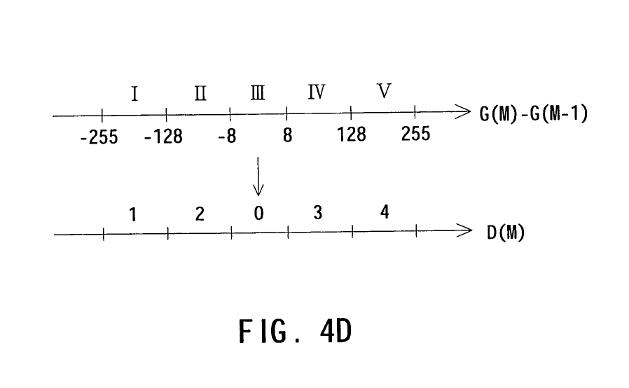

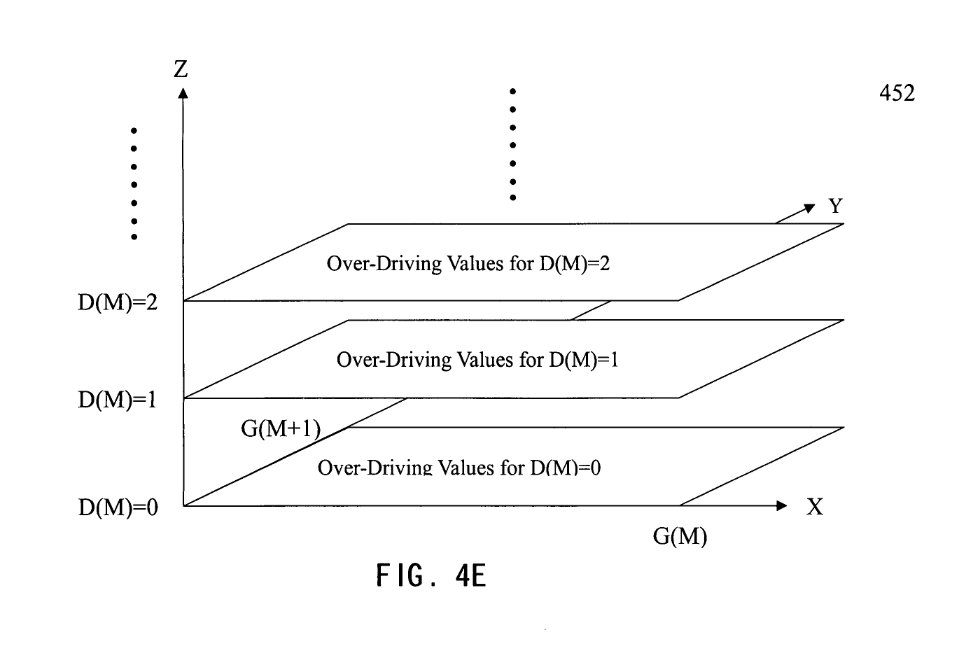

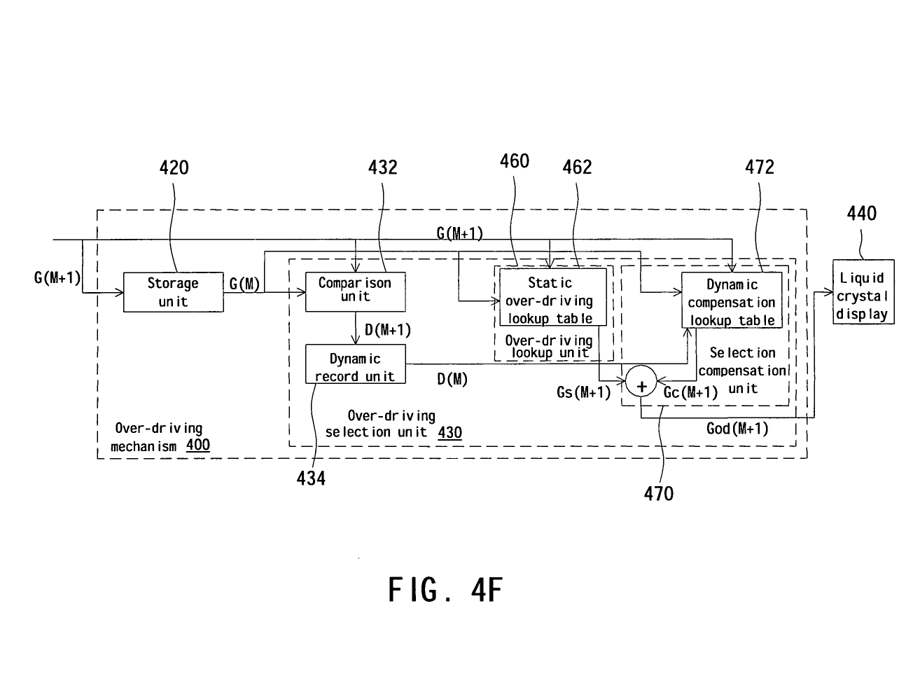

Referring to FIG. 4A, a block diagram of a portion of a display device, such as an LCD device, is depicted. The LCD device includes an over-driving mechanism 400 according to an embodiment. The LCD device has an LCD panel 440 with I×J resolution (in other words, the LCD panel 440 has an array of pixels having I rows and J columns). In another embodiment, the over-driving mechanism 400 can be part of a computer that is coupled to the display panel 440. The over-driving mechanism 400 receives the pixel gray value G(M+1, i, j) of the (i, j)-th pixel in the (M+1)-th frame, and accordingly outputs an over-driving gray value God(M+1, i, j) of the (i, j)-th pixel in the (M+1)-th frame, where 1≦i≦I, and 1≦j≦J. Although described from the perspective of a particular pixel, e.g., the (i, j)-th pixel, it is noted that similar processing is also occurring for the remaining pixels of the array.

The over-driving mechanism 400 includes a storage unit 420 and an over-driving selection unit 430. As used here, the term “unit” refers to any device, part of a device, assembly of devices, and/or software module. The storage unit 420 stores the pixel gray value G(M, i, j) of the (i, j)-th pixel in the M-th frame. The storage unit 420, such as frame memory, records the set of pixel gray values, {G(M, i, j)|i=1−I, j=1−J}, for the entire I×J array of pixels. The over-driving selection unit 430 is coupled to receive the G(M) data from the storage unit 420. The over-driving selection unit 430 outputs the over-driving gray value God(M+1, i, j) of the (i, j)-th pixel in the subsequent frame according to the pixel gray value G(M+1, i, j) of the subsequent frame, the pixel gray value G(M, i, j) of the first previous frame, and a comparison result of G(M, i, j) and G(M−1, i, j).

The over-driving selection unit 430 obtains the over-driving gray value God(M+1, i, j) by selecting an output of one of a static over-driving lookup table 435 and a dynamic over-driving lookup table 437. The output of the static over-driving lookup table 435 is selected if G(M−1, i, j) and G(M, i, j) remain static (or constant); in other words, the gray values of the immediately two preceding frames prior to the subsequent frame to be displayed for the (i, j)-th pixel has not changed. However, the over-driving selection unit 430 selects output of the dynamic over-driving lookup table 437 if G(M−1, i, j) and G(M, i, j) have changed.

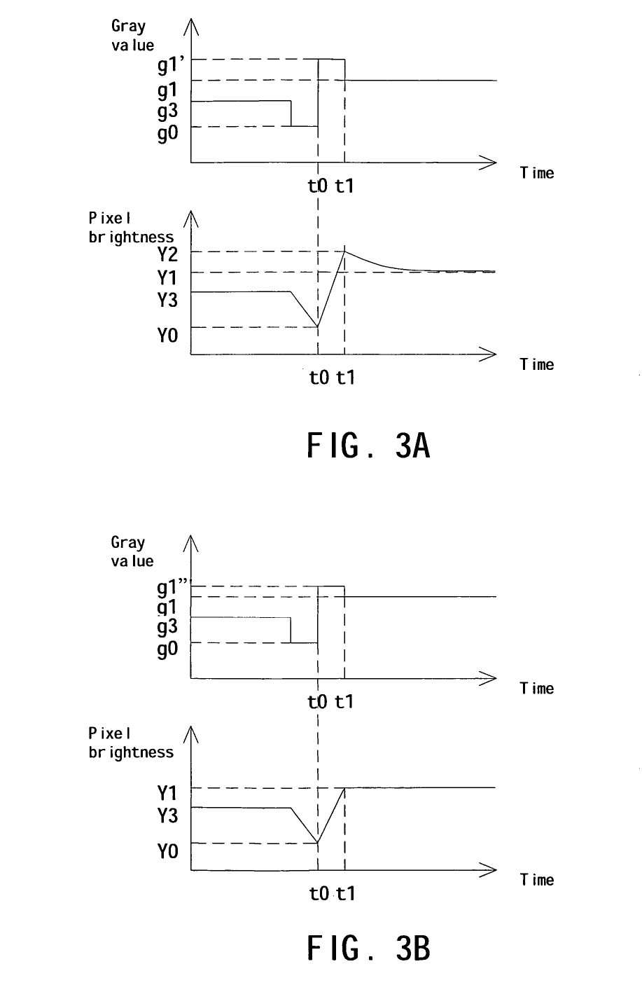

The content of the static and dynamic over-driving lookup tables 435 and 437 are different to reflect the differing behavior of liquid crystal molecules under the static and dynamic conditions. In the static condition, it is assumed that the liquid molecules for the (i, j)-th pixel has transitioned to the state corresponding to gray value G(M, i, j) due to the gray value having remained stable for at least two frames. In this condition, a first over-driving gray value is used. However, in the dynamic condition where G(M−1, i, j) and G(M, i, j) are different, the liquid crystal molecules may still be transitioning to the G(M, i, j) value. Therefore, to address this behavior, a second over-driving gray value is used instead of the first over-driving gray value. For example, as shown in FIG. 3B, instead of providing an over-driving gray scale value g1′ (first over-driving gray value) for the (i, j)-th pixel in the (M+1)-th frame (as is the case in the static condition depicted in FIG. 3A), a different value g1″ (second over-driving gray scale value) can be used instead. The over-driving gray value g1″ prevents the overshooting of the brightness depicted in FIG. 3A.

As shown in FIG. 4A, the over-driving selection unit 430 includes a comparison unit 432, a dynamic record unit 434, and a selection lookup unit 436. The comparison unit 432 is for comparing the pixel gray value G(M+1, i, j) of the subsequent frame and the pixel gray value G(M, i, j) of the first previous frame and accordingly outputs a comparison result value D(M+1, i, j). The “first previous frame” refers to the frame that is immediately prior to subsequent frame to be displayed (the (M+1)-th frame). The dynamic record unit 434, coupled to the comparison unit 432 and the selection lookup unit 436, is for outputting the comparison result value D(M, i, j) of the pixel gray values G(M−1, i, j) and G(M, i, j) of the last two frames, and recording the comparison result value D(M+1, i, j). The G(M−1, i, j) value is for the second previous frame (the (M−1)-th frame), which is the frame immediately prior to the M-th frame, and two frames back of the (M+1)-th frame. The comparison result D(M, i, j) was stored from processing the first previous frame (the M-th frame). The comparison result D(M+1, i, j) that is stored in the dynamic record unit 434 is used for processing the next subsequent frame, the (M+2)-th frame.

The selection lookup unit 436 obtains a static over-driving gray value Gs(M+1, i, j) according to the pixel gray value G(M+1, i, j) of the subsequent frame and the pixel gray value G(M, i, j) of the first previous frame by accessing the static over-driving lookup table 435, and obtains a dynamic over-driving gray value Gd(M+1, i, j) by accessing the dynamic over-driving lookup table 437. The selection lookup unit 436 selects one of the static over-driving gray value Gs(M+1, i, j) and the dynamic over-driving gray value Gd(M+1, i, j) for output to the LCD panel 440 as the over-driving gray value God(M+1, i, j). The selection of Gs or Gd is according to the comparison result value D(M, i, j). If D(M, i, j) has a first value, then the Gs(M+1, i, j) output is selected. However, if D(M, i, j) has a second value, then the Gd(M+1, i, j) output is selected.

In the following description, the notation (i, j) is omitted for better clarity.

In one embodiment, when the pixel gray value G(M−1) of the second previous frame has the same value as the pixel gray value G(M) of the first previous frame, the comparison result value D(M) is 0, and the value D⁻(M) is 1. D⁻(M) represents the inverse of D(M). Based on the comparison result value D(M) being equal to 0, the selection lookup unit 436 selects the output of the static over-driving lookup table 435 as the over-driving gray value God (M+1). Because the pixel gray values G(M−1) and G(M) of the last two frames are equal, an accurate over-driving gray value God(M+1) can be obtained by using the static over-driving lookup table 435. However, when the pixel gray values G(M−1) and G(M) of the last two frames are different, the comparison result value D(M) is 1 and the value D⁻(M) is 0. Therefore, based on the comparison result value D(M) being equal to 1, the selection lookup unit 436 selects the output of the dynamic over-driving lookup table 437 as the over-driving gray value God(M+1). Because the pixel gray values G(M−1) and G(M) are not equal, the dynamic over-driving lookup table 437, not the static over-driving lookup table 435, is selected to obtain an accurate over-driving gray value God (M+1).

As depicted in the embodiment of FIG. 4A, the over-driving gray scale God(M+1) is obtained as follows:
God(M+1)=D⁻(M)×Gs(M+1)+D(M)×Gd(M+1).
In other words, God(M+1) is equal to Gs(M+1) if D⁻(M)=1 and D(M)=0, but God(M+1) is equal to Gd(M+1) if D⁻(M)=0 and D(M)=1.

FIG. 4B depicts a block diagram of an over-driving mechanism 400 according to a variation of the FIG. 4A embodiment. The over-driving selection unit 430 of FIG. 4B includes the comparison unit 432, the dynamic record unit 434, an over-driving lookup unit 431 and a selection compensation unit 433. As with the FIG. 4A embodiment, the comparison unit 432 compares the pixel gray value G(M+1) of the subsequent frame with the pixel gray value G(M) of the first previous frame, and outputs the comparison result value D(M+1). The dynamic record unit 434, coupled to the comparison unit 432 and the selection compensation unit 433, is for outputting the comparison result value D(M) of the gray values G(M−1) and G(M) of the last two frames and recording the comparison result value D(M+1).

The over-driving lookup unit 431 outputs the static over-driving gray value Gs(M+1) according to the pixel gray value G(M+1) of the subsequent frame and the pixel gray value G(M) of the first previous frame by accessing the static over-driving lookup table 438. The selection compensation unit 433 then performs gray-value compensation on the static over-driving gray value Gs(M+1) according to the comparison result value D(M) of the last two frames before the subsequent frame, which D(M) value was stored in the dynamic record unit 434. The selection compensation unit 433 accesses a dynamic compensation lookup table 439 to retrieve a dynamic compensation gray value Gc(M+1), which is used to adjust the Gs(M+1) value, if needed, to produce the over-driving gray value God(M+1).

When the gray value G(M−1) of the second previous frame is the same as the gray value G(M) of the first previous frame, the comparison result value D(M) is 0. Thus, based on the comparison result value D(M) being equal to 0, the selection compensation unit 433 outputs the static compensation gray value Gs(M+1) to be the corresponding over-driving gray value God(M+1) without adjustment. However, when the pixel gray value G(M−1) of the second previous frame is different from the pixel gray value G(M) of the first previous frame, the comparison result value D(M) is 1. Thus, based on the comparison result value D(M) being equal to 1, the selection compensation unit 433 obtains a dynamic compensation gray value Gc(M+1) according to the pixel gray values G(M+1) and G(M) by accessing the dynamic compensation lookup table. Next, the selection compensation unit 433 adjusts the static over-driving gray value Gs(M+1) to output the over-driving gray value God(M+1) based on the following calculation:
God(M+1)=Gs(M+1)+D(M)×Gc(M+1).
Obtaining God(M+1) using the FIG. 4B mechanism is similar to obtaining God(M+1) using the FIG. 4A technique, except that the FIG. 4B technique adjusts the static over-driving gray value Gs(M+1) to compute God (M+1) in the dynamic scenario, whereas the FIG. 4A mechanism directly obtains the gray value for God(M+1) from a dynamic over-driving lookup table.

As described above, the value D(M) is set to 0 if the values G(M−1) and G(M) are equal, while the value D(M) is set to 1 if the values G(M−1) and G(M) are different. However, rather than checking for equality of G(M−1) and G(M), the over-driving selection unit 430 can instead check if G(M−1) and G(M) are within some predefined gray scale threshold (x) of each other. In this alternative, the value D(M) is set to 0 if the absolute difference value | G(M−1)−G(M) | of the gray values G(M−1) and G(M) is smaller than the threshold gray-value difference x, while the value D(M) is set to 1 if the absolute difference value | G(M−1)−G(M) | of the values G(M−1) and G(M) is not smaller than the threshold gray-value difference x. The threshold gray-value difference x can be adjusted according to noise experienced in a system (such as a display device or computer). For example, if the noise is large, a higher threshold gray-value difference x can be set to prevent noise from causing an improper influence on the calculation result. For example, for 8-bit image data (pixel gray values represented by an 8-bit parameter), the threshold gray-value difference can be set to the value 8. In an example that uses 6-bit image data, the threshold gray-value difference can be set to 2.

Referring to FIG. 4C, a block diagram of an over-driving mechanism according to another variation of the FIG. 4A embodiment is depicted. The over-driving selection unit 430 includes the comparison unit 432, the dynamic record unit 434, and an over-driving lookup unit 450. The comparison unit 432 is for comparing the pixel gray value G(M+1) of the subsequent frame and the pixel gray value G(M) of the first previous frame and outputting the comparison result D(M+1) accordingly. The dynamic record unit 434, coupled to the comparison unit 432 and the over-driving lookup unit 450, is for outputting the comparison result value D(M) of the last two frames. The dynamic record unit 434 also records the comparison result value D(M+1). The over-driving lookup unit 450 outputs the over-driving gray value God(M+1) according to the comparison result value of the last two frames, the pixel gray value G(M+1) of the subsequent frame, and the pixel gray value G(M) of the first previous frame by accessing a 3-D (three-dimensional) over-driving lookup table 452.

The comparison result value D(M) is set to one of plural possible values within a gray-value range corresponding to the gray-value difference (G(M)−G(M−1)) between the pixel gray values G(M) and G(M−1) of the last two frames. For example, as shown in FIG. 4D, the gray-value interval [−255, 255] is divided into 5 gray-value ranges. In this example, the value D(M) corresponding to the I-th gray value range [−255, −128] is 1. In other words, D(M) is equal to 1 if the difference between G(M) and G(M−1) is between [−255, −128]. The value D(M) corresponding to the II-th gray value range (−128, −8) is 2. The value D(M) corresponding to the III-th gray value range [−8, −8] is 0. The value D(M) corresponding to the IV-th gray value range (8, 128) is 3, while the value D(M) corresponding to the V-th gray value range [128, 255] is 4. More generally, the D(M) value is set to one of plural values, where the plural values correspond to plural differences between G(M) and G(M−1). The plural values for D(M) can be three or more values in some embodiments.

The 3-D over-driving lookup table 452 has content based on three input values. This is contrasted to the 2-D over-driving lookup tables used in FIGS. 4A-4B, where the content of each of the 2-D static or dynamic over-driving lookup tables is selected based on two input values G(M+1) and G(M). The three input values to select content of the 3-D over-driving lookup table 452 include G(M+1), G(M), and D(M). In other words, an entry of the lookup table 452 is selected based on a combination of the three input values.

An example portion of the 3-D over-driving lookup table 452 is depicted in FIG. 4E, which represents the table 452 as a graph having three dimensions (X, Y, Z). The X axis represents G(M) values, the Y axis represents G(M+1) values, and the Z axis represents D(M) values. Specific values of G(M), G(M+1), and D(M) map to a coordinate or location in the graph of FIG. 4E, which coordinate or location stores an over-driving gray value. This over-driving gray value retrieved from the 3-D over-driving lookup table 452 is output by the over-driving mechanism 400 as the God(M+1) value.

FIG. 4F depicts a block diagram of an over-driving mechanism that is yet another variation of the FIG. 4A embodiment. The over-driving selection unit 430 in the over-driving mechanism 400 of FIG. 4F includes the comparison unit 432, the dynamic record unit 434, an over-driving lookup unit 460, and a selection compensation unit 470. The comparison unit 432 and dynamic record unit 434 are the same as in the FIG. 4A embodiment.

The over-driving lookup unit 460 outputs the static over-driving gray value Gs(M+1) according to the pixel gray values G(M+1) and G(M). The selection compensation unit 470 obtains the dynamic compensation value Gc(M+1) from a 3-D dynamic compensation lookup table 472 for compensating the static over-driving gray value Gs(M+1) and outputs the over-driving gray value God(M+1) according to the comparison result value D(M) of the last two frames, and the pixel gray values G(M+1) and G(M), where God(M+1) is defined as follows: God(M+1)=Gs(M+1)+Gc(M+1). The input values to the 3-D dynamic compensation lookup table 472 include G(M+1), G(M), and D(M), where the table 472 is similar in structure to the table 452 depicted in FIG. 4E except that compensation gray values are provided in the table 472 rather than the over-driving gray values of the table 452. The value of D(M) can be one of plural values within a range, depending on the difference between G(M) and G(M−1) (similar to the selection of FIG. 4D).

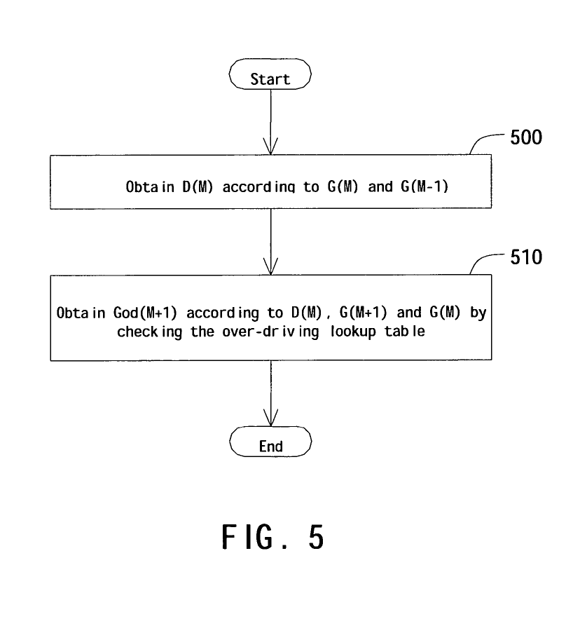

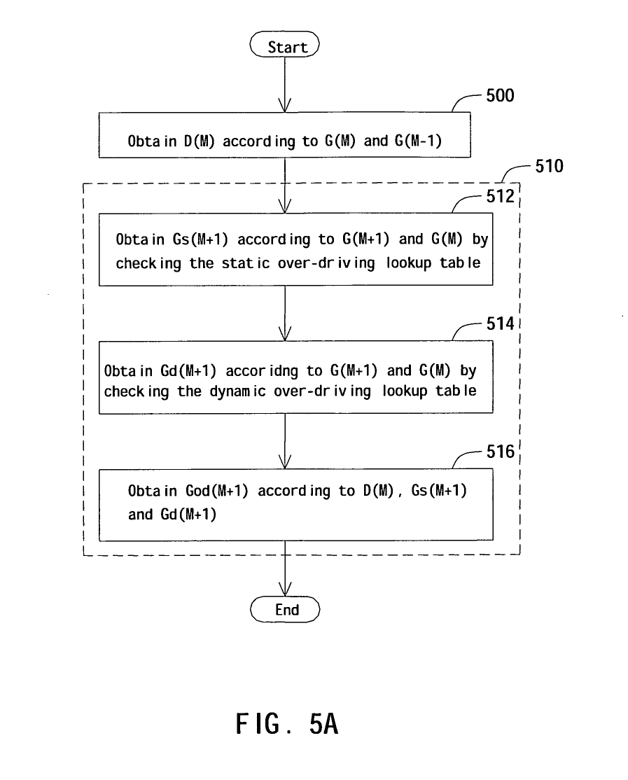

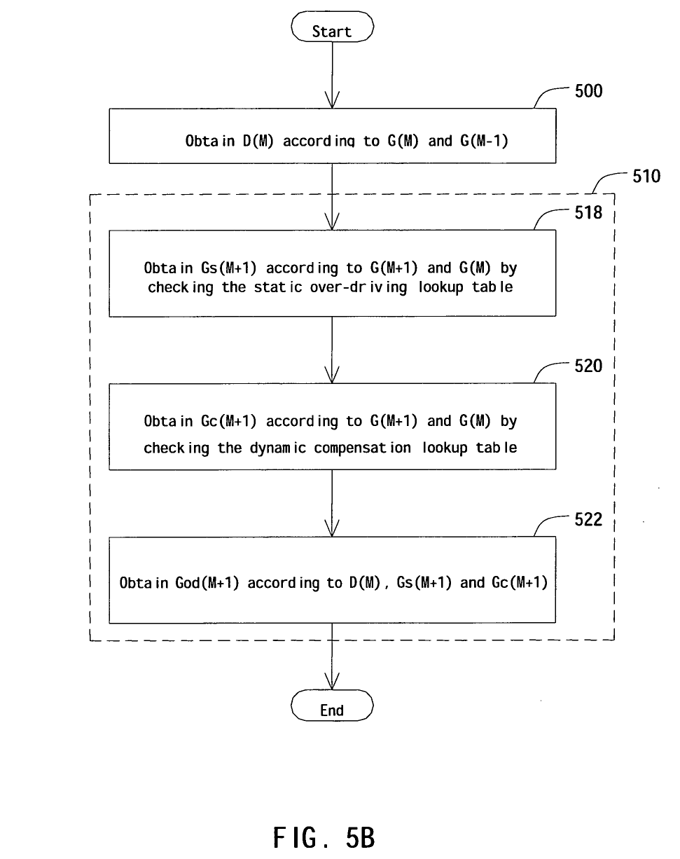

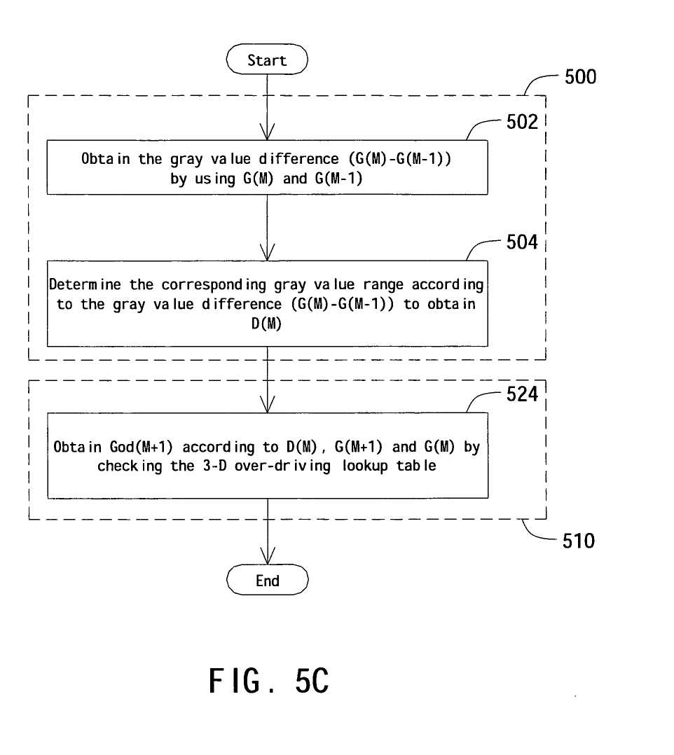

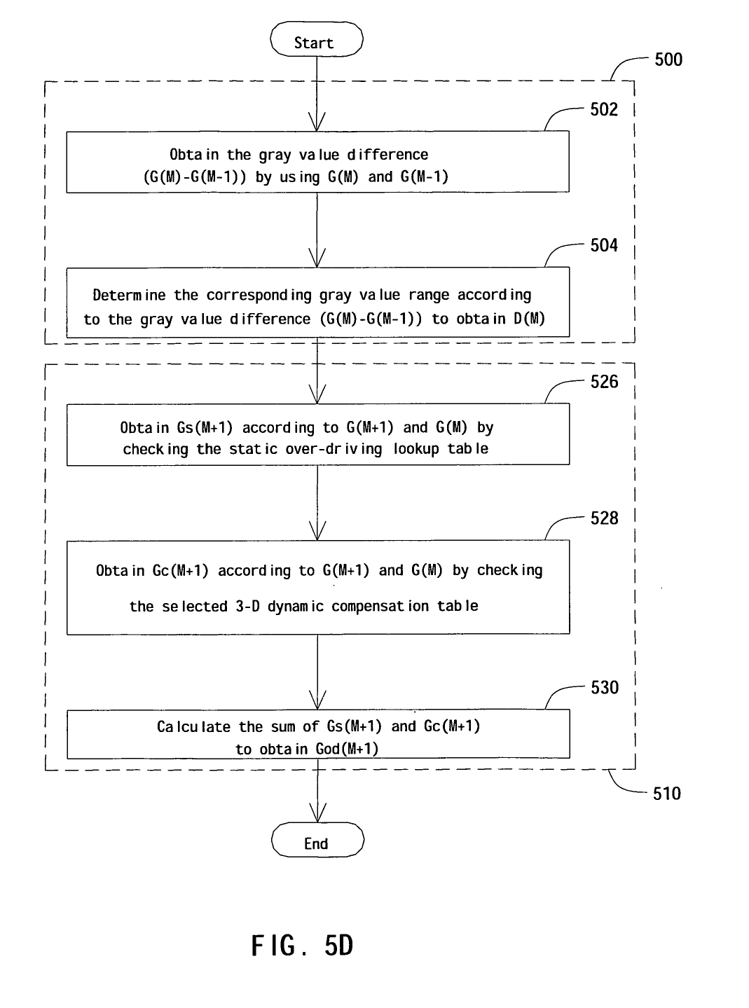

Referring to FIG. 5, a flow chart of the over-driving technique according to am embodiment is shown. The comparison result value D(M) based on the pixel gray values G(M) and G(M−1) is first obtained (at 500). Next, the over-driving gray value God (M+1) is obtained (at 510) based on the comparison result value D(M) and the gray values G(M+1) and G(M).

FIG. 5A shows a more detailed flow chart of the over-driving technique of FIG. 5, in which the over-driving mechanism of FIG. 4A is used. First, the corresponding comparison result value D(M) according to a comparison of the pixel gray value G(M) of the first previous frame with the pixel gray value G(M−1) of the second previous frame is obtained (at 500). When the absolute difference between the pixel gray values G(M) and G(M−1) is smaller than a threshold gray-value difference x, the comparison result value D(M) is set to 0 and D⁻(M) is set to 1. On the other hand, when the absolute difference of the pixel gray values G(M) and G(M−1) is not smaller than the threshold gray-value difference x, the comparison result value D(M) is set to 1 and D⁻(M) is set to 0. Next, the static over-driving gray value Gs(M+1) according to the pixel gray values G(M+1) and G(M) are obtained (at 512) from the static over-driving lookup table 435. The dynamic over-driving gray value Gd(M+1) according to the pixel gray values G(M+1) and G(M) is obtained (at 514) from the dynamic over-driving lookup table 437. Next, the over-driving gray value God(M+1) is obtained (at 516) by selecting one of the static over-driving gray value Gs(M+1) and the dynamic over-driving gray value Gd(M+1), based on D(M) and D⁻(M):
God(M+1)=D⁻(M)×Gs(M+1)+D(M)×Gd(M+1).

FIG. 5B shows a more detailed flow chart of the over-driving technique of FIG. 5 when using the FIG. 4B embodiment. The value of D(M) is obtained (at 500), where D(M) is set to 0 or 1 based on the factors discussed above. The static over-driving gray value Gs(M+1) is then obtained (at 518) according to the pixel gray values G(M+1) and G(M) from the static over-driving lookup table 438 of FIG. 4B. The dynamic compensation gray value Gc(M+1) is obtained (at 520) according to the pixel gray values G(M+1) and G(M) from the dynamic compensation lookup table 439 of FIG. 4B. The over-driving gray value God(M+1) is then obtained (at 522) as follows:
God(M+1)=Gs(M+1)+D(M)×Gc(M+1).

FIG. 5C shows a more detailed flow chart of the over-driving technique of FIG. 5 when the FIG. 4C embodiment is used. The gray value difference (G(M)−G(M−1)) is first obtained (at 502). Next, the gray value range corresponding to the gray value difference (G(M)−G(M−1)) is determined (at 504) to set the comparison result value D(M), such as according to FIG. 4D, where D(M)(=1, 2, 0, 3, 4) according to the gray value range I-V corresponding to the gray value difference (G(M)−G(M−1)). The over-driving gray value God(M+1) is then obtained (at 524) according to the comparison result value D(M) and the pixel gray values G(M+1) and G(M) from the 3-D over-driving lookup table 452.

FIG. 5D shows a more detailed flow chart of the over-driving technique of FIG. 5 when the FIG. 4F embodiment is used. The gray value difference (G(M)−G(M−1)) is first obtained (at 502). Next, the comparison result value D(M) is obtained (at 504) from a range of values based on the difference (G(M)−G(M−1)). The static over-driving gray value Gs(M+1) is obtained (at 526) according to the pixel gray values G(M+1) and G(M) from the static over-driving lookup table 462 of FIG. 4F. The dynamic compensation gray value Gc(M+1) is obtained (at 528) based on the comparison result value D(M) and the pixel gray values G(M+1) and G(M) from the 3-D dynamic compensation table 472. The sum of the static over-driving gray value Gs(M+1) and the dynamic compensation gray value Gc(M+1) is calculated (at 530) to obtain the over-driving gray value God(M+1). When the absolute difference of the pixel gray values G(M) and G(M−1) is smaller than the threshold gray value difference x, the dynamic compensation gray value Gc(M+1) is 0.

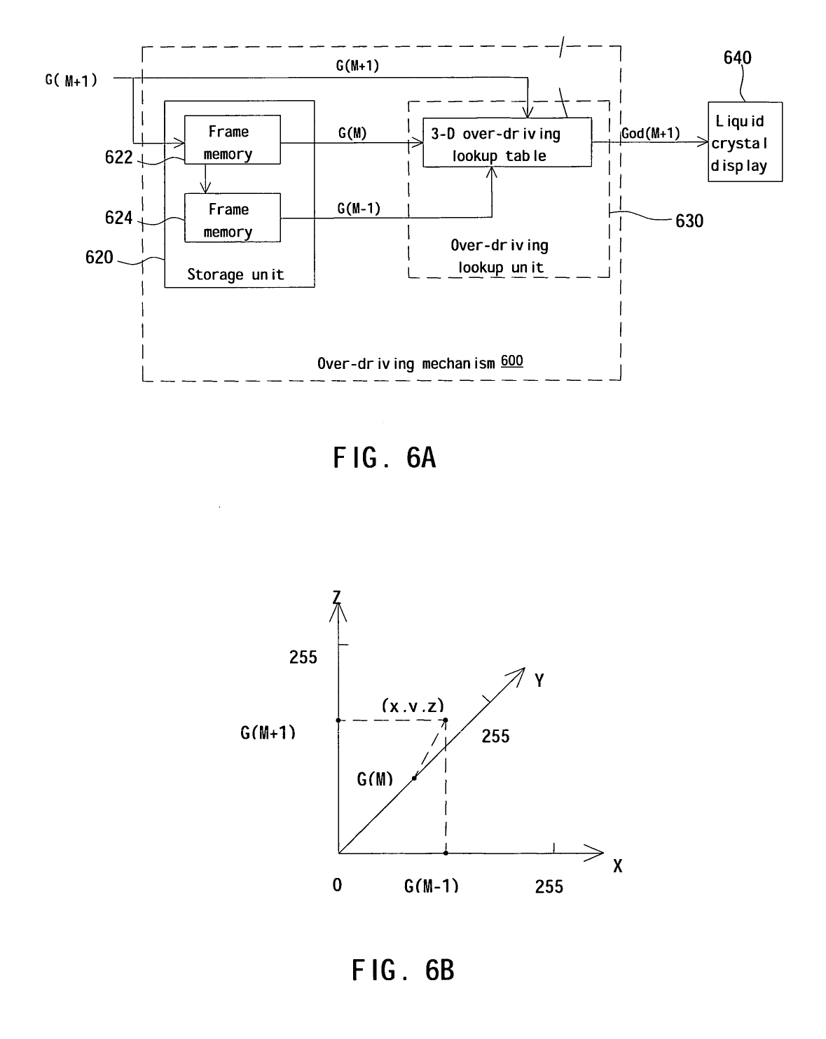

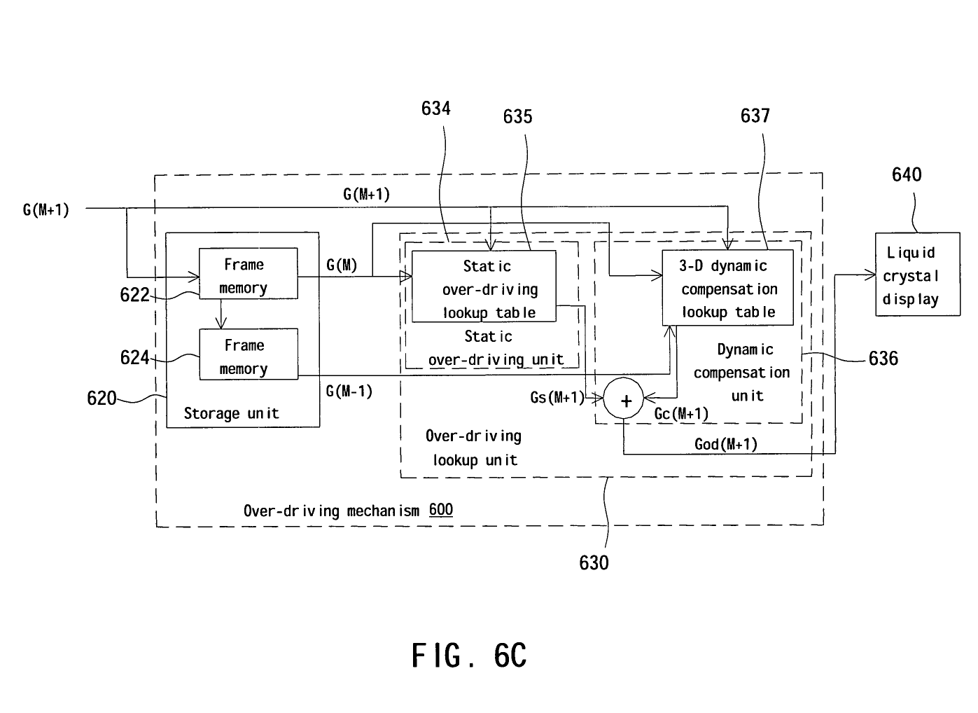

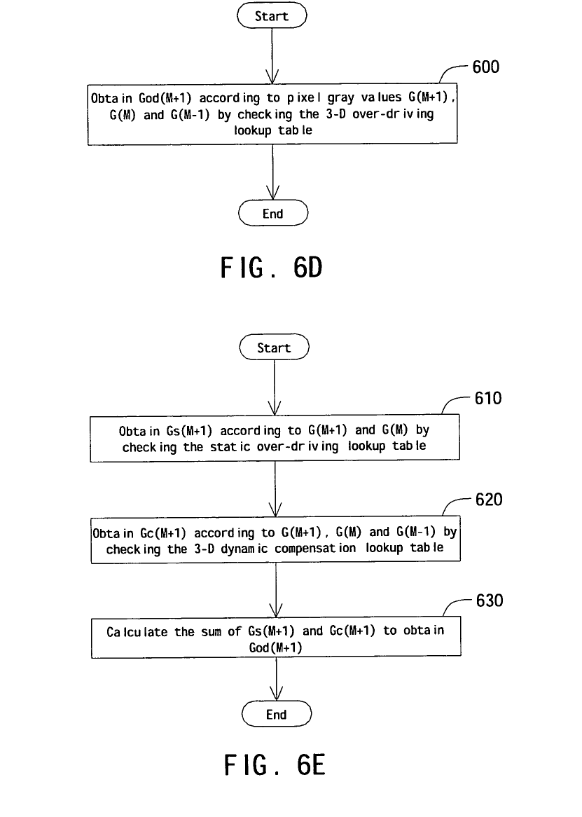

FIG. 6A shows a block diagram of a portion of a display device including an over-driving mechanism 600 according to another embodiment. The display device has an LCD panel 640 with I×J resolution. The over-driving mechanism 600 receives the gray value G(M+1, i, j) of the (i, j)-th pixel in the (M+1)-th frame and outputs the over-driving gray value God (M+1, i, j) of the in the (M+1)-th frame accordingly, where 1≦i≦I, 1≦j≦J. The over-driving mechanism 600 includes a storage unit 620 and an over-driving lookup unit 630. The storage unit 620 is for storing the pixel gray value G(M+1, i, j) of the (i, j)-th pixel in the (M+1)-th frame. The gray values {G(M, i, j) | i=1−I, j=1−J} of the M-th frame are stored in frame memory 622, while the pixel gray values of the (M−1)-th frame are stored in another frame memory 624. In the following description, the notation (i, j) is omitted for better clarity.

The over-driving lookup unit 630, coupled to the storage unit 620, is for outputting over-driving gray value God(M+1) to a liquid crystal display 640 according to the pixel gray value G(M+1) of the subsequent frame, the (M+1)-th frame, and the pixel gray values G(M) and G(M−1) of the last two frames by accessing a 3-D over-driving lookup table 632. The inputs to the 3-D over-driving lookup table 632 include G(M+1), G(M), and G(M−1). Specific values of G(M+1), G(M), and G(M−1) map to a location in the 3-D over-driving lookup table 632, which location stores an over-driving gray value God(M+1).

For example, as shown FIG. 6B, the 3-D over-driving lookup table 632 is represented as a graph having three axes (X, Y, Z). Assuming that each gray value is an 8-bit value, each of G(M+1), G(M), and G(M−1) can have 256 values ranging between 0 and 255. Each coordinate point (x, y, z) represents an over-driving gray value corresponding to values of G(M+1), G(M), and G(M−1).

FIG. 6C shows an over-driving mechanism according to a variation of the FIG. 6A embodiment. The over-driving lookup unit 630 of FIG. 6C includes a static over-driving unit 634 and a dynamic compensation unit 636. The static over-driving unit 634 outputs a static over-driving gray value Gs(M+1) according to the pixel gray values G(M+1) and G(M) from a static over-driving lookup table 635. The dynamic compensation unit 636 obtains a dynamic compensation gray value Gc(M+1) for compensating the static over-driving gray value Gs(M+1) and outputs the over-driving gray value God(M+1) (=Gs(M+1)+Gc(M+1)) according to pixel gray values G(M+1), G(M), G(M−1). The Gc(M+1) value is obtained by accessing a 3-D dynamic compensation lookup table 637 using G(M+1), G(M), and G(M−1) as inputs. The 3-D dynamic compensation lookup table 637 is similar to the 3-D dynamic over-driving lookup table 632 of FIG. 6A except that each coordinate point (X, Y, Z) of the 3-D dynamic compensation lookup table 637 denotes the gray value for compensating the static over-driving gray value Gs(M+1).

Referring to FIG. 6D, a flow chart of the over-driving technique of the FIG. 6A embodiment is shown. The over-driving gray value God(M+1) is obtained (at 600) according to the pixel gray values G(M+1), G(M), and G(M−1) from the 3-D over-driving lookup table 632 of FIG. 6A.

FIG. 6E shows a flow chart of the over-driving technique using the FIG. 6C embodiment. The static over-driving gray value Gs(M+1) is first obtained (at 610) according to the pixel gray values G(M+1) and G(M) from the static over-driving lookup table 635 of FIG. 6C. The dynamic compensation gray value Gc(M+1) is obtained (at 620) according to the pixel gray values G(M+1), G(M), and G(M−1) from the 3-D dynamic compensation lookup table 637. Next, the sum of the static over-driving gray value Gs(M+1) and the dynamic compensation gray value Gc(M+1) is calculated (at 630) to obtain the corresponding over-driving gray value God(M+1).

The over-driving mechanism according to the various embodiments may have the following benefit. By comparing the pixel gray values of the last two frames before the subsequent frame to be displayed and selecting a suitable over-driving gray value, the quality of motion pictures displayed by a display device can be improved over the quality of conventional display devices.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus for use with a display device having pixels, comprising:
a storage unit to store a gray value of a pixel for a first frame; and
an over-driving generation unit, coupled to the storage unit, to obtain an over-driving gray value of the pixel for a second frame to be displayed by the display device, the second frame subsequent to the first frame,
wherein the over-driving gray value is different from a target gray value of the pixel for the second frame, and
wherein the over-driving gray value is obtained by the over-driving generation unit according to at least the gray value of the pixel for the first frame, the target gray value of the pixel for the second frame, and a gray value of the pixel for a third frame that is prior to the first frame.

2. The apparatus of claim 1, further comprising a static lookup table and a dynamic lookup table, wherein the over-driving generation unit accesses the static lookup table to obtain a static gray value, and the over-driving generation unit accesses the dynamic lookup table to obtain a dynamic gray value, and
wherein the over-driving generation unit compares the gray value for the first frame with the gray value for the third frame to select one of the static gray value and the dynamic gray value as the over-driving gray value.

3. The apparatus of claim 2, wherein the over-driving generation unit comprises:
a comparison unit to compare the gray values for the first frame and third frame, and to output a comparison result value based on the comparing; and
a selection unit to obtain the static gray value from the static lookup table according to the gray value for the first frame and the target gray value for the second frame, and to obtain the dynamic gray value from the dynamic lookup table according to the gray value of the first frame and the target gray value of the second frame,
the selection unit to select one of the static gray value and the dynamic gray value according to the comparison result value.

4. The apparatus of claim 3, wherein the comparison result value has a first value in response to the gray values for the first frame and third frame differing by less than a predefined threshold, and the comparison result value has a second value in response to the gray values for the first frame and third frame not differing by less than the predefined threshold.

5. The apparatus of claim 1, further comprising a static lookup table and a compensation lookup table, wherein the over-driving generation unit accesses the static lookup table to obtain a static gray value, and the over-driving generation unit accesses the compensation lookup table to obtain a compensation gray value, and
wherein the over-driving generation unit compares the gray value for the first frame with the gray value for the third frame to select whether the compensation gray value is combined with the static gray value to compute the over-driving gray value.

6. The apparatus of claim 5, wherein the over-driving generation unit comprises:
a comparison unit to compare the gray values for the first frame and third frame, and to output a comparison result value based on the comparing; and
a selection unit to obtain the static gray value from the static lookup table according to the gray value for the first frame and the target gray value for the second frame, and to obtain the compensation gray value from the compensation lookup table according to the gray values for the first frame and the second frame,
the selection unit to output the static gray value as the over-driving gray value when the comparison result value has a first value, and to sum the static gray value with the compensation gray value when the comparison result value has a second value.

7. The apparatus of claim 5, wherein the comparison result value has a first value in response to the gray values for the first frame and third frame differing by less than a predefined threshold, and the comparison result value has a second value in response to the gray values for the first frame and third frame not differing by less than the predefined threshold.

8. The apparatus of claim 1, further comprising a three-dimensional lookup table, wherein the over-driving generation unit comprises a comparison unit to compare the gray values for the first frame and third frame, and to output a comparison result value based on the comparing,
wherein the over-driving generation unit accesses the three-dimensional lookup table to obtain the over-driving gray value from a location of the three-dimensional table corresponding to the gray value of the pixel for the first frame, the target gray value of the pixel for the second frame, and the comparison result value.

9. The apparatus of claim 8, wherein the comparison result value is a value generated by determining a gray value range corresponding to a gray value difference between the gray values of the pixel for the first frame and the third frame.

10. The apparatus of claim 1, further comprising a three-dimensional lookup table, wherein the over-driving generation unit accesses the three-dimensional lookup table to obtain the over-driving gray value from a location of the three-dimensional table corresponding to the gray value of the pixel for the first frame, the target gray value of the pixel for the second frame, and a gray value of the pixel for the third frame.

11. The apparatus of claim 1, further comprising a static lookup table and a three-dimensional compensation lookup table, wherein the over-driving generation unit accesses the static lookup table to obtain a static gray value, and the over-driving generation unit accesses the compensation lookup table to obtain a compensation gray value to combine with the static gray value to compute the over-driving gray value.

12. The apparatus of claim 11, wherein the over-driving generation unit comprises:
a comparison unit to compare the gray values for the first frame and third frame, and to output a comparison result value based on the comparing; and
a selection unit to obtain the static gray value from the static lookup table according to the gray value for the first frame and the target gray value for the second frame, and to obtain the compensation gray value from the three-dimensional compensation lookup table according to the gray value for the first frame, the target gray value for the second frame, and the comparison result value.

13. The apparatus of claim 11, wherein the over-driving generation unit comprises:
a selection unit to obtain the static gray value from the static lookup table according to the gray value for the first frame and the target gray value for the second frame, and to obtain the compensation gray value from the three-dimensional compensation lookup table according to the gray value for the first frame, the target gray value for the second frame, and the gray value for the third frame.

14. An over-driving apparatus, for use with a liquid crystal display, for receiving a plurality of pixel gray values of a pixel in a plurality of frames and outputting a plurality of over-driving gray values accordingly, the over-driving apparatus comprising:
a storage unit for storing the pixel gray values; and
an over-driving generation unit, coupled to the storage unit, for outputting an over-driving gray value of the pixel in a particular frame according to the pixel gray values of the pixel in at least three of the plurality of frames, the at least three frames including the particular frame.

15. The over-driving apparatus of claim 14, wherein the over-driving generation unit outputs the over-driving gray value according to the pixel gray values of the pixel in the at least three frames by accessing a three-dimensional over-driving lookup table.

16. The over-driving apparatus of claim 14, wherein the over-driving generation unit comprises:
a static over-driving unit to output a static over-driving gray value by accessing a static over-driving lookup table according to the pixel gray values of the pixel in the particular frame and in a second frame that is prior to the particular frame;
a dynamic compensation unit to obtain a dynamic compensation gray value to compensate the static over-driving gray value and output the over-driving gray value by accessing a three-dimensional dynamic compensation lookup table according to the pixel gray values of the pixel in the particular frame, the second frame, and a third frame that is prior to the second frame.

17. The over-driving apparatus of claim 14, wherein the over-driving generation unit comprises:
a static over-driving unit to output a static over-driving gray value by accessing a static over-driving lookup table according to the pixel gray values of the pixel in the particular frame and in a second frame that is prior to the particular frame;
a dynamic compensation unit to obtain a dynamic gray value by accessing a second over-driving lookup table, the dynamic gray value to substitute for the static over-driving gray value or to compensate the static over-driving gray value for generating the over-driving gray value.

18. A method for use with a display device, comprising:
providing pixel gray values of a pixel for a plurality of frames, the plurality of frames comprising first, second, and third frames, the second frame prior to the first frame, and the third frame prior to the second frame; and
generating an over-driving gray value of the pixel for the first frame according to at least the pixel gray values of the pixel in first, second, and third frames, wherein the over-driving gray value for the first frame is different from the pixel gray value of the pixel for the first frame.

19. The method of claim 18, wherein generating the over-driving gray value comprises:
accessing a static lookup table to obtain a static gray value;
accessing a dynamic lookup table to obtain a dynamic gray value; and
comparing the pixel gray value for the second frame with the pixel gray value for the third frame to select one of the static gray value and the dynamic gray value as the over-driving gray value.

20. The method of claim 19, wherein generating the over-driving gray value further comprises:
producing a comparison result value based on comparing the pixel gray values for the second frame and third frame,
wherein the static gray value is obtained from the static lookup table according to the pixel gray values for the first frame and second frame, and the dynamic gray value is obtained from the dynamic lookup table according to the pixel gray values for the first frame and the second frame,
wherein one of the static gray value and the dynamic gray value is selected according to the comparison result value as the over-driving gray value.

21. The method of claim 18, wherein generating the over-driving gray value comprises:
accessing a static lookup table to obtain a static gray value;
accessing a compensation lookup table to obtain a compensation gray value; and
comparing the pixel gray value for the second frame with the pixel gray value for the third frame to select whether the compensation gray value is combined with the static gray value to compute the over-driving gray value.

22. The method of claim 18, wherein generating the over-driving gray value comprises:
comparing the pixel gray values for the second frame and third frame, and outputting a comparison result value based on the comparing; and
accessing a three-dimensional lookup table to obtain the over-driving gray value from a location of the three-dimensional table corresponding to the pixel gray values of the pixel for the first and second frames and the comparison result value.

23. The method of claim 22, wherein outputting the comparison result value comprises generating the comparison result value by determining a gray value range corresponding to a gray value difference between the pixel gray values of the pixel for the second frame and the third frame.

24. The method of claim 18, wherein generating the over-driving gray value comprises:
accessing a three-dimensional lookup table to obtain the over-driving gray value from a location of the three-dimensional table corresponding to the pixel gray values of the pixel for the first, second, and third frames.

25. The method of claim 18, wherein generating the over-driving gray value comprises:
accessing a static lookup table to obtain a static gray value; and
accessing a compensation lookup table to obtain a compensation gray value to combine with the static gray value to compute the over-driving gray value.

26. The method of claim 25, wherein the compensation lookup table comprises a three-dimensional compensation lookup table, and wherein generating the over-driving gray value comprises:
comparing the pixel gray values for the second frame and third frame, and outputting a comparison result value based on the comparing;
obtaining the static gray value from the static lookup table according to the pixel gray values of the first and second frames; and
obtaining the compensation gray value from the three-dimensional compensation lookup table according to the pixel gray values for the first and second frames and the comparison result value.

27. The method of claim 25, wherein the compensation lookup table comprises a three-dimensional compensation lookup table, and wherein generating the over-driving gray value comprises:
obtaining the static gray value from the static lookup table according to the pixel gray values for the first and second frames;
obtaining the compensation gray value from the three-dimensional compensation lookup table according to the pixel gray values for the first, second, and third frames.
